(19) United States
(12) Patent Application Publication
(10) Pub. No.: US 2004/0090113 A1
(43) Pub. Date: May 13, 2004

(54) Method for checking a pressure fluid reservoir

(76) Inventors: Arnold Pahl, Markgroeningen (DE); Johann Guggemos, Blaichach (DE); Harald Hermann, Friolzheim (DE); Guenter Krenz, Steinheim (DE); Horst Beling, Weinsberg (DE)

Correspondence Address: RONALD E. GREIGG, GREIGG & GREIGG P.L.L.C., Suite One, 1423 Powhatan Street, Alexandria, VA, 22314, US

(21) Appl. No.: 10/636,547

(22) Filed: Aug. 8, 2003

(30) Foreign Application Priority Data
Aug. 8, 2002 (DE) 1 02 36 391.9

(51) Int. Cl. B60T 8/34

(52) U.S. Cl. 303/113.4

(57) ABSTRACT

A method is disclosed for monitoring a pressure fluid reservoir that is equipped with an elastically-shaped media-separating element and a terminal position seal in which fluid reservoir is connected in a pressure fluid loop having a pressure generator driven by a drive unit and having at least one measuring instrument, which detects a parameter representing the operating pressure in the pressure fluid loop. The parameter is delivered to an electronic control unit, where it is further processed into a trigger signal, among others for the drive unit of the pressure generator. After the operating pressure in the pressure fluid loop has dropped below a prestressing pressure the drive unit of the pressure generator is triggered by the control unit, and via a predeterminable time interval beginning with this triggering, the signal course of the measuring instrument is plotted by the control unit and compared with a suitably memorized set-point value course. Deviations in the signal course in the positive direction allow conclusions to be drawn about possible damage in the pressure fluid reservoir, particularly at the terminal position seal.

### BACKGROUND OF THE INVENTION

1. Field of the Invention

The invention is directed to an improved method for checking a pressure fluid reservoir equipped with an elastically-shaped media-separating element and a terminal position seal.

2. Description of the Prior Art

Pressure fluid reservoirs of the type with which this invention is concerned are already known, for instance from German Patent Disclosure DE 100 30 937 A1 and are used, among other places, in anti-lock brake systems of motor vehicles, particularly in electrohydraulic brake systems with an emergency brake operated by muscle power and a service brake operated by external force, in order to store hydraulic braking energy.

This known braking energy is generated by existing pressure generators. The brake systems furthermore include measuring instruments for evaluating braking events; these instruments detect a parameter representing the pressure in the brake circuit, convert it into an electrical variable, and supply it to an electronic control unit. This variable is further processed by the control unit into trigger signals for control valves that are also present, and by way of them regulation of the braking event is accomplished.

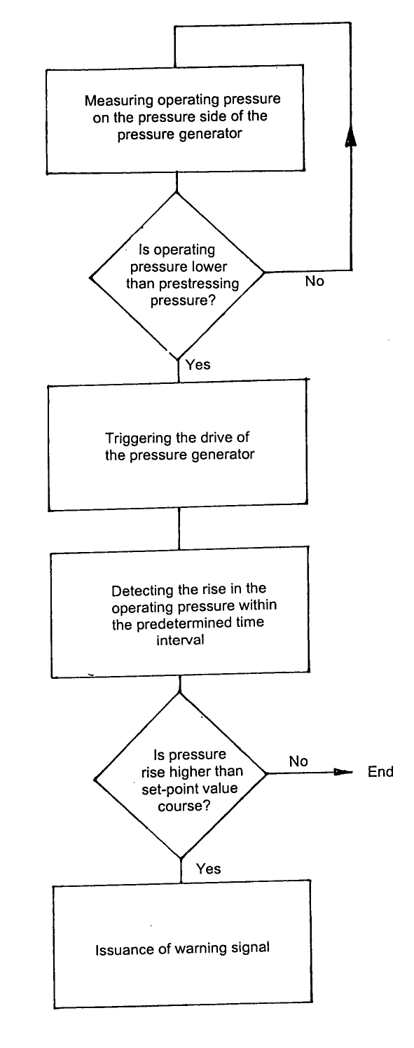

The known pressure fluid reservoir of FIG. 1 of the aforementioned reference, with its housing, encloses a pressure chamber in which a media-separating element is disposed. Serving as the media-separating element is a cylindrical bellows, preferably of metal, which because of its corrugated wall is elastic in shape. This bellows is anchored in a pressure-fluidproof manner by its first, open end to the inside of the housing, while its opposite second end, although also closed off in pressure-fluidproof fashion by a cap, is disposed longitudinally movably in the interior of the housing. On the flanged face of the housing oriented toward the second end of the bellows, a terminal position seal is inserted into an annular recess provided for it. This terminal position seal protrudes with a formed-on sealing bead, extending all the way around, from the bottom face of the housing in the direction of the bellows. For an operative connection to the cap of the bellows, the terminal position seal has a smaller outer diameter than the bellows. Inside the terminal position seal, the inlet of the pressure fluid reservoir discharges into the pressure chamber, surrounding the bellows, of the housing.

In the position of the bellows as shown, a hydraulic pressure fluid that fills up the pressure chamber around the bellows is at high pressure. At the bellows itself, which in this first terminal position is compressed to its minimum volume, a force equilibrium prevails between this hydraulic pressure force and the counterpressure force prevailing in the interior of the bellows. This counterpressure force is accomplished by a gas with which the bellows is filled, and consequently it rises as the compression of the bellows increases. If the pressure force in the pressure chamber surrounding the bellows drops, then this counterpressure force causes the bellows to expand its volume, until in an extreme case it rests with its cap on the terminal position seal and has thus reached its terminal position. If the terminal position seal is undamaged, the pressure chamber surrounding the bellows is sealed off from the inlet in this terminal position, so that even if the pressure drops further in the inlet, there is a pressure and force equilibrium on the faces of the bellows that are located inside the pressure chamber. For actuating the bellows, a pressure equilibrium must merely be established again, via the hydraulic pressure fluid located in the inlet, at the face of the cap that is enclosed by the terminal position seal element.

In the event of a defect, that is, if a terminal position seal is damaged, the pressure in the pressure chamber surrounding the bellows would depressurize toward the inlet connection. This would destroy the pressure equilibrium at the bellows, and the counterpart force resulting from the gas charge would inflate the bellows. If this event occurs repeatedly, material fatigue can occur and finally cracks in the bellows, through which the gas in the interior of the bellows can reach the pressure fluid. In motor vehicle brake systems, pressure fluid contaminated with gas is a major safety risk, since unlike the hydraulic pressure fluid, gas is highly compressible.

In the system disclosed in DE 100 30 937 A1, the pressure fluid reservoir is equipped with an additional sensor system, for monitoring its function. The sensor system trips a signal as soon as the cap of the media-separating element reaches the vicinity of its terminal position. A disadvantage is that the requisite sensor system necessitates electrical contacting of the pressure fluid reservoir and makes its assembly and installation process more difficult. Moreover, the number of individual parts and hence the system costs are also increased.

From German Patent Disclosure DE 197 01 070 A1, the functional circuit diagram of an electrohydraulic brake system is also known. This brake system includes a service brake actuated by external force and an emergency brake actuated manually. The two brake systems are coupled together via a brake actuating unit, and a pressure fluid container and a brake pedal are operatively connected to the brake actuating unit. The emergency brake actuated manually has two separate brake circuits, which if the service brake is functional are decoupled from the wheel brake cylinders of the front wheels via electrically triggerable disconnection valves. The disconnection valves are electromagnetically triggerable 2/2-way valves, which are open in their basic position and are switched into their blocking position if the service brake is functional.

The emergency brake actuated by external force includes a pressure generator, driven by an electrical drive unit; a pressure fluid reservoir, downstream of the pressure generator, of the structural type described at the outset above; and a measuring instrument, which generates an electrical parameter representing the pressure in the pressure line of the pressure generator and delivers it to an electronic control unit. The pressure line leads via electromagnetically triggerable pressure buildup valves to the wheel brake cylinders of the various wheels of a motor vehicle; these pressure buildup valves are embodied as 2/2-way valves, and in their nontriggered basic position, they are closed. Also branching off from the various wheel brake cylinders are return lines leading back to the intake side of the pressure generator; they are equipped with pressure reduction valves. These pressure reduction valves are also electrically triggerable by the control unit, so that in a braking event initiated via the brake pedal, the pressure in the various wheel brake cylinders can be controlled for individual wheels by the control unit as a function of the friction ratios between the various wheels of the motor vehicle and the roadway. These friction ratios are detected via wheel rotation sensors and are also evaluated in the electronic control unit. Detecting the pressures at the wheel brake cylinders of the vehicle wheels for controlling the brake system is done by means of further pressure sensors that are known per se.

### OBJECT AND SUMMARY OF THE INVENTION

The object of the present invention is to propose a method for checking a pressure fluid reservoir that is provided with a media-separating element and a terminal position seal, which with a pressure fluid reservoir of the simplest possible construction allows reliable ascertainment of damage to the terminal position seal without requiring additional sensor systems for the purpose.

A method for checking a pressure fluid reservoir has the advantage that because complicated sensor systems in the pressure fluid reservoir are dispensed with, installation space, installation effort, weight, and costs are all saved.

Further advantages and advantageous refinements of the invention will become apparent from the description. For instance, if the course between the set-point and actual-value characteristic curve shows a deviation, a warning signal can be issued by the control unit; if the proposed method is used in a brake system of a motor vehicle, this signal indicates the malfunction to the driver. This tells the driver to look for a repair facility, where the damaged pressure fluid reservoir can be replaced. Because of the method proposed, the incident repair costs can be kept low. Furthermore, the method can be realized economically by software provisions in the electronic control unit.

Because of the proposed method, a failure of he media-separating element can averted. In motor vehicle brake systems, where as a rule one of the pressure chambers of the pressure fluid reservoir is filled with gas, this prevents gas from getting into the pressure chamber filled with hydraulic pressure fluid and furthermore reaching a wheel brake cylinder connected to it. Since pressure fluid contaminated with gas, depending on the stress on the brake system, can lead to an overly soft brake pedal and in an extreme case, because of the compressibility of gases, to the total failure of the brake system, an invasion of gas into the hydraulic pressure fluid is averted by the proposed method, and the operating safety of a motor vehicle is markedly enhanced.

### BRIEF DESCRIPTION OF THE DRAWING

The invention will be better understood and further objects and advantages thereof will become more apparent from the ensuing detailed description of a preferred embodiment taken in conjunction with the single drawing figure which is a flow chart illustrating the successive method steps in an exemplary embodiment of the invention.

### DESCRIPTION OF THE PREFERRED EMBODIMENT

The first method step of the method of the invention comprises measuring the operating pressure on the pressure side of the pressure generator, using the measuring instrument present in the existing system. This measuring instrument converts the outcome of measurement into an electrical variable and sends that signal on to an electronic control unit. In the control unit, the question is then asked whether the measured operating pressure is higher or lower than a defined prestressing pressure. This prestressing pressure depends on the design of the pressure fluid reservoir and is stored in memory as a set-point value in the electronic control unit. If the measured operating pressure is higher than the prestressing pressure, then the measuring operation described at the outset is repeated at intervals over time. However, if the measured actual value is less than the set-point value, then the control unit triggers the drive unit of the pressure generator. Simultaneously with the output of the trigger signal, in a next method step, the course of the pressure rise in the pressure line of the pressure generator over a predetermined time interval, stored in memory in the control unit, is measured by the measuring instrument and picked up by the control unit. Next, a comparison with a set-point value course, also stored in memory, is performed. If this comparison shows a substantially steady course, without substantial differences in terms of gradient or maximum value, then the conclusion drawn is that the terminal position seal is operating properly, and the checking process is terminated.

However, if the comparison shows marked deviations in the positive direction between the set-point value course and the actual-value course, then from this the conclusion is drawn that the terminal position seal element is damaged, and the control unit issues a warning signal. This warning signal tells the driver to go to an appropriate repair facility, in order to correct the defects found and thus restore the operating safety of the vehicle.

As discussed above, the checking method described does not require additional sensor systems in the pressure fluid reservoir, because it merely uses the measuring instruments already necessary in the brake system.

The invention is based on the recognition that once the operating pressure in the pressure line of the pressure generator drops below a defined prestressing pressure determined by the particular design, it is assured that the cap of the bellows in the pressure fluid reservoir is resting on the terminal position seal, and in that case, the pressure chamber surrounding the bellows is disconnected from the inlet to the pressure fluid reservoir. With the onset of a pressure buildup, if the terminal position seal is functioning properly, the pressure level in the pressure line rises essentially steadily over time, since the bellows is in a state of pressure equilibrium.

Conversely, if the terminal position seal were defective, that is, if there were a leak, then the pressure in the pressure chamber surrounding the bellows would also have dropped, and a force component in the opening direction of the bellows, which component exists because of the difference in outside diameter between the terminal position seal and the bellows, would be absent. The pressure generator would therefore at least briefly have to furnish a substantially higher pressure than if the terminal position seal were functional, in order to compress the bellows. Moreover, after the lifting of the bellows from the damaged terminal position seal, the pressure level would have to drop at least briefly, until the original pressure level has built up again in the pressure chamber that is now open toward the inlet. This pressure course differs because of this inconstancy from the pressure course when the terminal position seal is undamaged. This difference is evaluated according to the invention by the control unit and interpreted as a malfunction of the pressure fluid reservoir.

It is understood that changes or advantageous refinements of the invention are conceivable without departing from the fundamental concept of the invention. In this respect, it should be noted that the ambient temperature has a substantial effect on the measured actual value, and therefore to avoid a false alarm, the ambient temperature should also be taken into account, as a further input variable in the control unit.

The foregoing relates to a preferred exemplary embodiment of the invention, it being understood that other variants and embodiments thereof are possible within the spirit and scope of the invention, the latter being defined by the appended claims.

We claim:

1. A method for checking a pressure fluid reservoir with an elastically-shaped media-separating element, which separates two pressure chambers acted upon by pressure fluid from one another, in which the media-separating element is disposed movably with one of its ends between two terminal positions, and having a terminal position seal which seals off an inlet of the pressure fluid reservoir from one of the two pressure chambers in a terminal position of the media-separating element, and the pressure fluid reservoir is connected via the inlet into a pressure fluid loop, in particular the pressure fluid loop of an anti-lock brake system of a motor vehicle, and in the pressure fluid loop, there are a pressure generator, coupled with a drive unit, and a measuring instrument which detects a parameter that represents the operating pressure in the pressure fluid loop, converts it into an electrical signal, and sends it to an electronic control unit, and the control unit further processes the signal into a trigger signal for the drive unit of the pressure generator, among other elements, the method comprising, triggering the drive unit of the pressure generator by the control unit after the operating pressure in the pressure fluid loop has dropped below a prestressing pressure predetermined by the design of the pressure fluid reservoir, and plotting the signal course of the measuring instrument by the control unit and comparing the signal course with a set-point value course stored in memory in the control unit via a predetermined time interval from the time of triggering the pressure generator.

2. The method according to claim 1, further comprising issuing a warning signal by the control unit upon deviations between the actual-value course and the set-point value course.

3. The method according to claim 2, wherein the warning signal is issued if the actual-value course is higher than the set-point value course.

4. The method according to claim 1, a pressure sensor that detects the pressure in the pressure line of the pressure generator is used as the measuring instrument; and wherein as the set-point value course, the pressure rise in the time interval is evaluated.

5. The method according to claim 2, a pressure sensor that detects the pressure in the pressure line of the pressure generator is used as the measuring instrument; and wherein as the set-point value course, the pressure rise in the time interval is evaluated.

6. The method according to claim 3, a pressure sensor that detects the pressure in the pressure line of the pressure generator is used as the measuring instrument; and wherein as the set-point value course, the pressure rise in the time interval is evaluated.

7. The method according to claim 1, wherein, as the media-separating element, a bellows, in particular a metal bellows with an open first end structurally connected to the housing and a closed, movable second end is used.

8. The method according to claim 2, wherein, as the media-separating element, a bellows, in particular a metal bellows with an open first end structurally connected to the housing and a closed, movable second end is used.

9. The method according to claim 3, wherein, as the media-separating element, a bellows, in particular a metal bellows with an open first end structurally connected to the housing and a closed, movable second end is used.

10. The method according to claim 4, wherein, as the media-separating element, a bellows, in particular a metal bellows with an open first end structurally connected to the housing and a closed, movable second end is used.

11. The method according to claim 5, wherein, as the media-separating element, a bellows, in particular a metal bellows with an open first end structurally connected to the housing and a closed, movable second end is used.

12. The method according to claim 6, wherein, as the media-separating element, a bellows, in particular a metal bellows with an open first end structurally connected to the housing and a closed, movable second end is used.
